(19) United States
(12) Patent Application Publication
(10) Pub. No.: US 2024/0039112 A1
(43) Pub. Date: Feb. 1, 2024

(54) TRACTION BATTERY PACK VENTING SYSTEM AND VENTING METHOD

(71) Applicant: Ford Global Technologies, LLC, Dearborn, MI (US)

(72) Inventors: Di Zhu, Novi, MI (US); John Peter Bilezikjian, Canton, MI (US); Christopher Steven Baldwin, Royal Oak, MI (US)

(21) Appl. No.: 17/878,156

(22) Filed: Aug. 1, 2022

(51) Int. Cl. H01M 50/383; H01M 50/209

(52) U.S. Cl. CPC H01M 50/383; H01M 50/209; H01M 2220/20

(57) ABSTRACT

A traction battery pack venting system includes at least one battery cell configured to provide a venting area to vent gases in response to a predetermined condition. The system further includes an enclosure for the at least one battery cell, wherein the enclosure has a surface that faces the venting area. A plurality of textured forms are spaced across the surface to spread vented gas over the surface.

### TECHNICAL FIELD

This disclosure relates generally to a traction battery pack and, in particular, to a method and apparatus for more evenly distributing vented gas away from a traction battery pack enclosure surface.

### BACKGROUND

Electrified vehicles differ from conventional motor vehicles because electrified vehicles can be selectively driven using one or more electric machines powered by a traction battery pack. The electric machines can drive the electrified vehicles instead of, or in addition to, an internal combustion engine. A traction battery pack of an electrified vehicle can include one or more battery arrays within an enclosure. The battery arrays each include a plurality of individual battery cells.

### SUMMARY

In some aspects, the techniques described herein relate to a traction battery pack venting system, wherein the system includes at least one battery cell configured to provide a venting area to vent gases in response to a predetermined condition and an enclosure for the at least one battery cell. The enclosure has a surface that faces the venting area, and a plurality of textured forms are spaced across the surface to spread vented gas over the surface

In some aspects, the techniques described herein relate to a traction battery pack venting system, wherein the plurality of textured forms comprise a plurality of pins.

In some aspects, the techniques described herein relate to a traction battery pack venting system, wherein the plurality of pins comprise discrete pins defined by a maximum outer dimension, and wherein the discrete pins are spaced apart from each other by a distance that is within a range of one to two times the maximum outer dimension.

In some aspects, the techniques described herein relate to a traction battery pack venting system, wherein the plurality of textured forms are comprised of a material that sublimates to a non-flammable gas when a threshold gas temperature is exceeded.

In some aspects, the techniques described herein relate to a traction battery pack venting system, wherein the material comprises epoxy, polyester, sheet molding compound, thermoplastic, glass fiber, or pentaerythritol phosphate.

In some aspects, the techniques described herein relate to a traction battery pack venting system, wherein the plurality of textured forms comprise a plurality of weaves.

In some aspects, the techniques described herein relate to a traction battery pack venting system, wherein the plurality of weaves are comprised of a ceramic, graphite, or metal material.

In some aspects, the techniques described herein relate to a traction battery pack venting system, wherein the plurality of textured forms comprise a plurality of ribs having a length that is greater than a width.

In some aspects, the techniques described herein relate to a traction battery pack venting system, wherein the plurality of ribs have a V-shape cross-section.

In some aspects, the techniques described herein relate to a traction battery pack venting system, wherein the plurality of textured forms are molded within the surface of the enclosure to extend outwardly toward the at least one battery cell.

In some aspects, the techniques described herein relate to a traction battery pack venting system, wherein the system includes a plurality of battery arrays within a traction battery pack, the battery arrays each having a plurality of individual battery cells, and at least one vent associated with one or more of the plurality of individual battery cells. The system further includes an enclosure for the traction battery pack, wherein the enclosure has an external surface and an internal surface that faces the at least one vent. A plurality of textured forms are spaced across the internal surface to more evenly distribute vented gas over the internal surface.

In some aspects, the techniques described herein relate to a traction battery pack venting system, wherein the plurality of textured forms comprise a plurality of discrete pins or ribs that are spaced apart from each other across the internal surface.

In some aspects, the techniques described herein relate to a traction battery pack venting system, wherein the plurality of textured forms comprise the plurality of pins which are each defined by a maximum outer dimension, and wherein the plurality of pins are spaced apart from each other by a distance that is within a range of one to two times the maximum outer dimension.

In some aspects, the techniques described herein relate to a traction battery pack venting system, wherein the plurality of textured forms comprise the plurality of ribs, and wherein each rib has a V-shape cross-section.

In some aspects, the techniques described herein relate to a traction battery pack venting system, wherein the plurality of textured forms are comprised of a material that sublimates to a non-flammable gas when a threshold gas temperature is exceeded.

In some aspects, the techniques described herein relate to a traction battery pack venting system, wherein the plurality of textured forms comprise a plurality of weaves that are comprised of a fiber based material.

In some aspects, the techniques described herein relate to a traction battery pack venting system, wherein the plurality of textured forms are molded within the internal surface of the enclosure to extend outwardly toward the at least one vent.

In some aspects, the techniques described herein relate to a traction battery pack venting method, the method including the step of: incorporating a plurality of textured forms spaced across an inner surface of a battery pack enclosure to spread gas vented by at least one battery cell more evenly over the inner surface.

In some aspects, the techniques described herein relate to a traction battery pack venting method, the method including forming the plurality of textured forms as pins, ribs, and/or weaves that are spaced apart from each other across the inner surface.

In some aspects, the techniques described herein relate to a traction battery pack venting method, the method including: forming the plurality of textured forms from a material that sublimates to a non-flammable gas when a threshold gas temperature is exceeded; and/or molding the plurality of textured forms within the internal surface of the enclosure to extend outwardly toward a vent of the at least one battery cell.

The embodiments, examples and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

### BRIEF DESCRIPTION OF THE FIGURES

The various features and advantages of the disclosed examples will become apparent to those skilled in the art from the detailed description. The figures that accompany the detailed description can be briefly described as follows:

FIG. 1 illustrates a side view of an electrified vehicle having a traction battery pack.

FIG. 2 illustrates a perspective, expanded view of portions of the traction battery pack of FIG. 1.

FIG. 3A illustrates a schematic side view of one example of a pack cover that is used to spread out vented gas from a cell of the traction battery pack of FIG. 2.

FIG. 3B illustrates a schematic internal surface view the pack cover of FIG. 3A.

FIG. 4A illustrates a schematic side view of another example of a pack cover that is used to spread out vented gas from a cell of the traction battery pack of FIG. 2.

FIG. 4B illustrates a schematic internal surface view the pack cover of FIG. 4A.

FIG. 5A illustrates a schematic side view of another example of a pack cover that is used to spread out vented gas from a cell of the traction battery pack of FIG. 2.

FIG. 5B illustrates a schematic internal surface view the pack cover of FIG. 5A.

FIG. 6A illustrates a schematic side view of another example of a pack cover that is used to spread out vented gas from a cell of the traction battery pack of FIG. 2.

FIG. 6B illustrates a schematic internal surface view the pack cover of FIG. 6A.

### DETAILED DESCRIPTION

Under some conditions, one or more battery cells of a traction battery pack can expel relatively high temperature gaseous byproducts. The gas byproducts can be expelled through vents of the battery cells as vented gases.

The vented gases can be relatively high temperature gases. During a venting event, thermal energy from the venting battery cells and the vented gases can be focused on one small area of a battery pack enclosure. This focus of thermal energy can be undesirable.

This disclosure is directed toward directing vented gases from the battery pack in ways that can reduce the focus of thermal energy on one small area and instead spread the thermal energy more evenly across an inner surface of the battery pack enclosure.

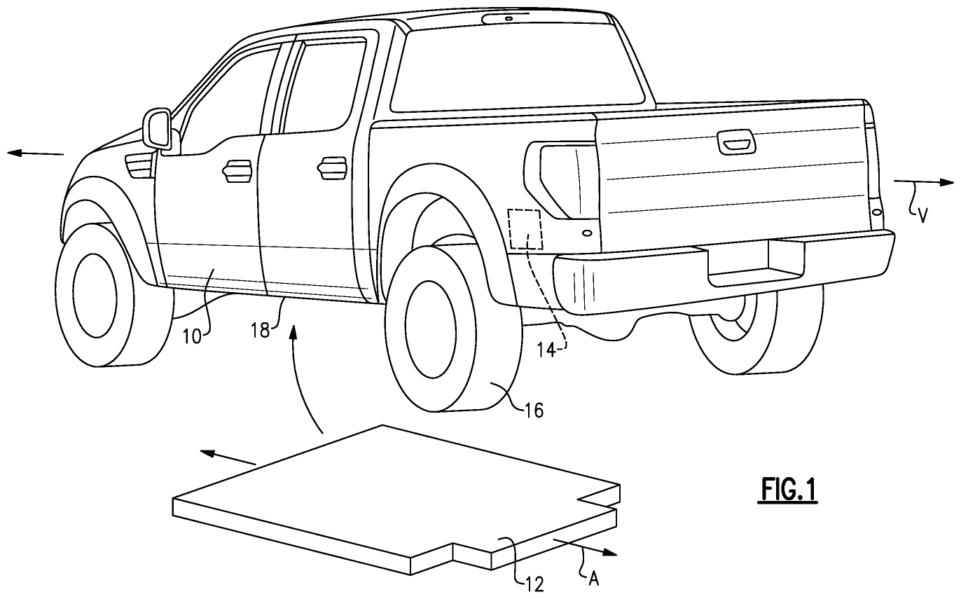

With reference to FIG. 1, an electrified vehicle 10, in an exemplary non-limiting embodiment, includes a traction battery pack 12, at least one electric machine 14, and a plurality of wheels 16. The traction battery pack 12 can provide electrical power to the electric machine 14, which converts the electric power to torque to drive the wheels 16.

The traction battery pack 12 can be a relatively high-voltage battery. The traction battery pack 12 is considered a traction battery pack at least because electrical energy from the traction battery pack 12 can be used to propel the electrified vehicle 10.

The traction battery pack 12 is, in the exemplary embodiment, secured to an underbody 18 of the electrified vehicle 10. The traction battery pack 12 could be located elsewhere on the electrified vehicle 10 in other examples. The traction battery pack 12 can be secured to the underbody 18 utilizing mechanical fasteners that engage structural rails of the electrified vehicle 10, for example. When secured to the underbody 18, a longitudinal axis A of the traction battery pack 12 is substantially aligned with a longitudinal axis V of the electrified vehicle 10.

The electrified vehicle 10 is an all-electric vehicle. In other examples the electrified vehicle 10 is a hybrid electric vehicle, which electively drives wheels using torque provided by an internal combustion engine instead of, or in addition to, torque provided by the electric machine 14 powered by the traction battery pack 12. Generally, the electrified vehicle 10 could be any type of vehicle having a traction battery pack 12.

With reference now to FIG. 2 and continuing reference to FIG. 1, the traction battery pack 12 includes an enclosure 20 that houses a plurality of battery arrays 22. In this example, there are the same number of battery arrays 22 on a passenger side of the traction battery pack 12 as are on a driver side of the traction battery pack 12. Other battery array configurations are also possible.

In one example, the enclosure 20 comprises a bottom wall 24 that supports the battery arrays 22, and a pair of end walls 26 that are connected to each other by a pair of side walls 28 to form a box shape. A cover 30 is placed over the box-shaped structure to enclose the battery arrays 22 within the enclosure 20.

The individual battery arrays 22 each include a plurality of individual battery cells 32. In one example, the individual battery cells 32 each include a vent 34. When pressure within one of the battery cells 32 increases to a predetermined pressure level, that battery cell 32 will vent gas out of the cell 32 in a direction toward the cover 30, for example.

In another example, a group of two or more battery cells 32 may share a vent 34.

In another example, the vent 34 may be positioned to face the bottom wall 24, end walls 26, and/or side walls 28.

In another example, the vents 34 could be arranged to face a plurality of different walls 24, 26, 28 and/or the cover 30.

In another example, a battery cell may comprise a pouch style cell that may not have a defined vent; however, a perimeter seal of the pouch may open at any point around the perimeter to comprise a venting portion or venting area that vents gases in response to pressure reaching a predetermined level.

Gaseous byproducts and debris vented from one of the battery cells 32 moves through the vent 34 for that battery cell 32 and is typically expelled against a small sized area on the wall surface that faces the vent 34. The hot gas and debris may adversely affect the structure of the enclosure cover 30 due to ablative forces as the gas and debris are directed toward the same small area on the cover 30. The adverse effects can include perforation, rupture, matrix degradation, and delamination, for example. It is not desirable to thicken the enclosure cover and/or add an additional layer between the battery cells 32 and the cover 30 because of the limited packaging space and/or the possibility of trapping additional heat.

The subject disclosure comprises a traction battery pack venting system that provides a plurality of textured forms 40 that are spaced across an inner surface of the enclosure 20 to spread vented debris/gas over a wider area of the inner surface. Thus, instead of having kinetic and thermal energy focused at a small spot on the inner surface, the energy from the hot vent gas and debris is spread out over a greater area of the inner surface so that the above-described adverse effects are reduced. The vented gases can then be expelled from the enclosure 20 into an atmosphere around the electrified vehicle 10 using traditional methods if needed.

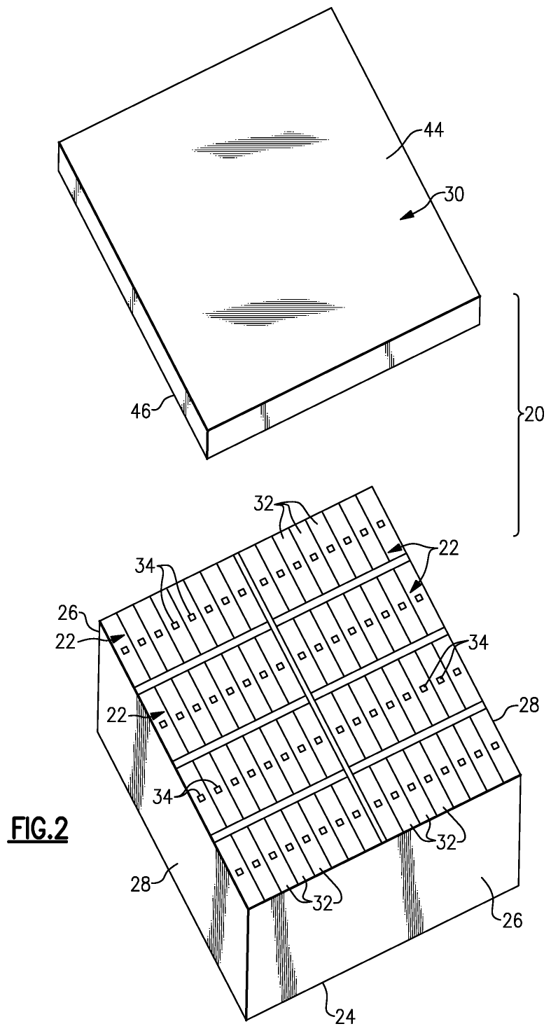

In one example shown in FIGS. 3A-3B, the plurality of textured forms 40 comprise a plurality of pins 42. The enclosure 20 includes an external surface 44 and an internal surface 46. In the example shown in FIGS. 3A-3B, the pins 42 comprise discrete structures that protrude outwardly of the internal surface 46 of the enclosure 20. In one example, the internal surface 46 is on the cover 30. The pins 42 may be round pins or could have other shapes. When a round pin 42 is used, the pins 42 could be curved relative to the surface 46 at an angle within a range between 30° to 60°. When the hot gas and debris GD hit these pins 42, the gas and debris get deflected in multiple different directions (see arrows 38). In addition, the pins 42 create a turbulent effect in the gas flow that enhances the spreading out of the energy. Furthermore, these pins 42 act as a group of miniature heat sinks, such that the pins 42 enhance the effective heat transfer area of the cover 30 while allowing gas to flow over them with minimum pressure drop.

In one example shown in FIG. 3B, the plurality of pins 42 comprise discrete pins defined by a maximum outer dimension D1. In one example, adjacent pins 42 are spaced apart from each other by a distance D2 that is within a range of one to two times the maximum outer dimension. As an example, the maximum outermost dimension D1, e.g. a diameter, of each pin 42 may be 1 cm and the distance D2 between adjacent pins 42 may be 1 to 2 cm. Depending on the distance between the cover 30 and the cells 32, the outermost dimension D1 of the pin 42 and the distance D2 between pins may change accordingly to achieve optimal performance.

In another example shown in FIGS. 4A-4B, the plurality of textured forms 40 comprise a plurality of weaves 48 that are used to deflect the gas and debris. In one example, the weaves 48 are comprised of a fiber based structure. For example, the weaves 48 may be made of ceramic, graphite, or metal. The weaves 48 have a lot of surface area to deflect the gas and debris. In one example, the weaves 48 comprise a textured or roughened surface that extends across an entirety of the internal surface 46 as shown in FIG. 4B, or the weaves 48 can comprise discrete structures that are spaced apart from each as shown in FIG. 4A in a pattern that would be similar as that shown with the pins in FIG. 3B.

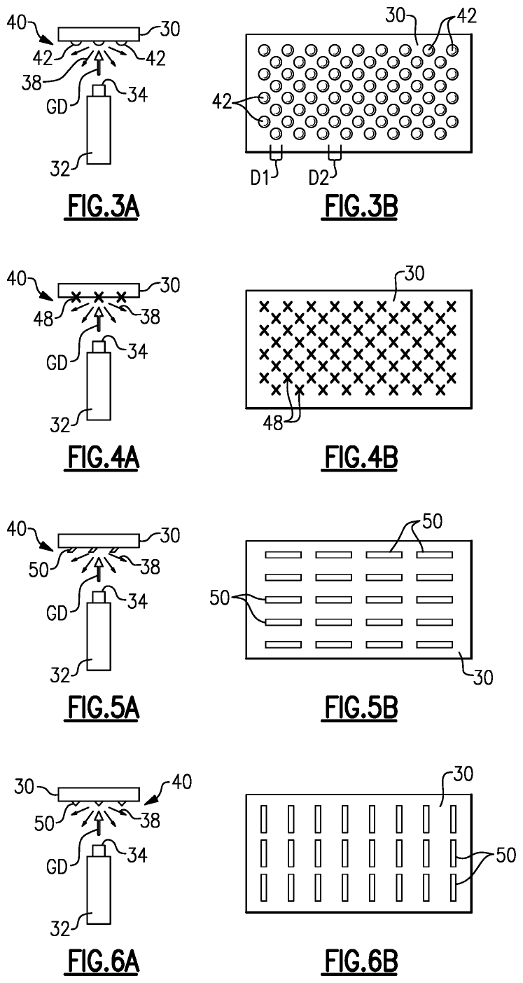

In another example, the plurality of textured forms 40 comprise a plurality of ribs 50 that are used to deflect the gas and debris. In one example, each of the ribs 50 have a length that is greater than a width. In one example, the ribs 50 have a V-shaped cross-section. The orientation of the ribs 50 can be vertical, horizontal, or a combination of both. The ribs 50 can be formed as part of the cover 30 or added on to the cover 30. The ribs 50 can also be placed on other areas of the enclosure 20 dependent on which direction the vents 34 face. FIG. 5A illustrates the horizontal ribs 50. FIG. 6A shows vertical ribs 50. FIG. 5B shows a plurality of discrete ribs 50 that extend horizontally. FIG. 6B shows a plurality of discrete ribs 50 that extend vertically. When hot gas and debris hit these ribs 50, they will be deflected in at least two different directions.

In one example, the plurality of textured forms 40 are molded within the surface of the enclosure 20 itself to extend outwardly toward the vents 34 of the at least one battery cell 32. These molded structures can comprise the pins 32, weaves 48, and/or ribs 50 in any combination.

In another example, the plurality of textured forms 40 are comprised of a material that sublimates to a non-flammable gas when a threshold gas temperature is exceeded. The material comprises, for example, an epoxy, polyester, sheet molding compound (SMC), thermoplastic, glass fiber, pentaerythritol phosphate, or other similar material. The plurality of textured forms 40 made from this material can comprise pins, ribs, or weaves as described above. In this example, the textured forms 40 get sublimated to a non-flammable gas when their temperature exceeds a specific temperature threshold (e.g., 400° C.). As the sublimation takes place, some of the energy is absorbed while the gas and debris is also being deflected by the textured form itself.

The preceding description is exemplary rather than limiting in nature. Variations and modifications to the disclosed examples may become apparent to those skilled in the art that do not necessarily depart from the essence of this disclosure. Thus, the scope of protection given to this disclosure can only be determined by studying the following claims.

What is claimed is:

1. A traction battery pack venting system, comprising:
at least one battery cell configured to provide a venting area to vent gases in response to a predetermined condition;
an enclosure for the at least one battery cell, wherein the enclosure has a surface that faces the venting area; and
a plurality of textured forms spaced across the surface to spread vented gas over the surface.

2. The traction battery pack venting system of claim 1, wherein the plurality of textured forms comprise a plurality of pins.

3. The traction battery pack venting system of claim 2, wherein the plurality of pins comprise discrete pins defined by a maximum outer dimension, and wherein the discrete pins are spaced apart from each other by a distance that is within a range of one to two times the maximum outer dimension.

4. The traction battery pack venting system of claim 1, wherein the plurality of textured forms are comprised of a material that sublimates to a non-flammable gas when a threshold gas temperature is exceeded.

5. The traction battery pack venting system of claim 4, wherein the material comprises epoxy, polyester, sheet molding compound, thermoplastic, glass fiber, or pentaerythritol phosphate.

6. The traction battery pack venting system of claim 1, wherein the plurality of textured forms comprise a plurality of weaves.

7. The traction battery pack venting system of claim 6, wherein the plurality of weaves are comprised of a ceramic, graphite, or metal material.

8. The traction battery pack venting system of claim 1, wherein the plurality of textured forms comprise a plurality of ribs having a length that is greater than a width.

9. The traction battery pack venting system of claim 8, wherein the plurality of ribs have a V-shape cross-section.

10. The traction battery pack venting system of claim 1, wherein the plurality of textured forms are molded within the surface of the enclosure to extend outwardly toward the at least one battery cell.

11. A traction battery pack venting system, comprising:
a plurality of battery arrays within a traction battery pack, the battery arrays each having a plurality of individual battery cells;
at least one vent associated with one or more of the plurality of individual battery cells; and
an enclosure for the traction battery pack, wherein the enclosure has an external surface and an internal surface that faces the at least one vent; and
a plurality of textured forms spaced across the internal surface to more evenly distribute vented gas over the internal surface.

12. The traction battery pack venting system of claim 11, wherein the plurality of textured forms comprise a plurality of discrete pins or ribs that are spaced apart from each other across the internal surface.

13. The traction battery pack venting system of claim 12, wherein the plurality of textured forms comprise the plurality of pins which are each defined by a maximum outer dimension, and wherein the plurality of pins are spaced apart from each other by a distance that is within a range of one to two times the maximum outer dimension.

12. The traction battery pack venting system of claim 12, wherein the plurality of textured forms comprise the plurality of ribs, and wherein each rib has a V-shape cross-section.

15. The traction battery pack venting system of claim 11, wherein the plurality of textured forms are comprised of a material that sublimates to a non-flammable gas when a threshold gas temperature is exceeded.

16. The traction battery pack venting system of claim 11, wherein the plurality of textured forms comprise a plurality of weaves that are comprised of a fiber based material.

17. The traction battery pack venting system of claim 11, wherein the plurality of textured forms are molded within the internal surface of the enclosure to extend outwardly toward the at least one vent.

18. A traction battery pack venting method comprising:
incorporating a plurality of textured forms spaced across an inner surface of a battery pack enclosure to spread gas vented by at least one battery cell more evenly over the inner surface.

19. The traction battery pack venting method of claim 18, including forming the plurality of textured forms as pins, ribs, and/or weaves that are spaced apart from each other across the inner surface.

20. The traction battery pack venting method of claim 18, including
forming the plurality of textured forms from a material that sublimates to a non-flammable gas when a threshold gas temperature is exceeded, and/or
molding the plurality of textured forms within the internal surface of the enclosure to extend outwardly toward a vent of the at least one battery cell.
